(19) United States
(12) Patent Application Publication
(10) Pub. No.: US 2025/0188951 A1
(43) Pub. Date: Jun. 12, 2025

(54) PROPULSION SYSTEM FOR AN AIRCRAFT

(71) Applicant: SAFRAN AIRCRAFT ENGINES, Paris (FR)

(72) Inventors: Eva Julie LEBEAULT, MOISSY-CRAMAYEL (FR); Fernando GEA AGUILERA, MOISSY-CRAMAYEL (FR); Anthony BINDER, MOISSY-CRAMAYEL (FR); Clément COTTET, MOISSY-CRAMAYEL (FR)

(73) Assignee: SAFRAN AIRCRAFT ENGINES, Paris (FR)

(21) Appl. No.: 18/845,636

(22) PCT Filed: Mar. 3, 2023
(86) PCT No.: PCT/FR2023/050293

§ 371 Date: Sep. 10, 2024

(30) Foreign Application Priority Data
Mar. 11, 2022 (FR) 2202171

(51) Int. Cl. F04D 29/54; B64D 27/12; F04D 29/56

(52) U.S. Cl. CPC F04D 29/544; B64D 27/12; F04D 29/563

(57) ABSTRACT

An aeronautical thruster of longitudinal axis includes a hub, an annular row of unducted upstream rotor blades, and an annular row of unducted downstream stator blades. The annular row of downstream stator blades includes at least one downstream stator blade of a first type, each of which is located about the longitudinal axis in a first angular sector about the longitudinal axis. Each downstream stator blade of the first type has a fixed pitch. The annular row of downstream blades further includes at least one downstream stator blade of a second type, each of which is located about the longitudinal axis outside said first angular sector, wherein each downstream stator blade of the second type has a variable pitch.

### TECHNICAL FIELD

The present disclosure relates to aeronautical thrusters with a longitudinal axis comprising (at least) two annular rows of unducted blades, one upstream and one downstream, along the longitudinal axis.

The aeronautical thruster can comprise (at least) one thermal engine, in particular turbomachine, turboshaft, turbojet, turbofan, and/or (at least) one electric motor, and/or (at least) one hydrogen engine, and/or (at least) one hybrid engine: thermal and/or electric and/or hydrogen.

### PRIOR ART

In the following, we will only refer to the case of turbomachines, since the type(s) of engine(s) included in the aeronautical thruster is not decisive here.

An “unducted” turbomachine (or “Propfan” or “Open rotor” or “Counter-Rotating Open Rotor” turboprop) is a type of turbomachine in which the fan (or propeller) extends outside the engine housing (or basket), in contrast to conventional turbomachines (of the “Turbofan” type) in which the fan is ducted. An example of such a turbomachine is shown in FIG. 1. The turbomachine 10 comprises a hub 12, defining the engine housing, and having mounted thereon an annular row of unducted upstream blades 14 and an annular row of unducted downstream blades 16 which are spaced apart from each other along a longitudinal axis X of the turbomachine 10. The annular row of upstream blades 14 and the annular row of downstream blades 16 define an upstream propeller and a downstream propeller respectively. Orientation qualifiers, such as “longitudinal”, “radial” or “circumferential”, are defined with reference to the longitudinal axis X of the turbomachine 10. The relative terms “upstream” and “downstream” are defined with respect to each other with reference to the flow of gases in the turbomachine 10 along the longitudinal axis X. Furthermore, the turbomachine 10 comprises, from upstream to downstream inside the engine housing, one or more compressors 2, at least one combustion chamber 4, one or more turbines 6 and at least one exhaust nozzle 8.

Amongst these unducted fan turbomachines, we know the “Unducted Single (or Stator) Fan” (USF) turbomachines in each of which, as illustrated in FIG. 1, the annular row of unducted upstream blades 14 is mounted so as to be able to rotate around the longitudinal axis X and the annular row of unducted downstream blades 16 is fixed. In other words, the annular row of upstream blades 14 is of rotor type and the annular row of downstream blades 16 is of stator type. The direction of rotation of the upstream rotor blades 14 is not decisive. The annular row of downstream stator blades 16 can be centred on an axis coincident or not with the longitudinal axis X. As shown in FIG. 1, the annular row of downstream stator blades 16 is centred on the longitudinal axis X. Such a USF configuration allows the gyration energy of the airflow from the upstream propeller to be used through the downstream propeller. The efficiency of the turbomachine 10 is thus improved, especially compared to a conventional turbomachine with a single rotating propeller. The upstream unducted rotor blades 16 are driven in rotation about the longitudinal axis X by the turbine(s) 6 which itself drives the compressor(s) 2. The turbomachine 10 usually includes a gearbox to decouple the speed of rotation of the turbines 6 from the speed of rotation of the upstream propeller. Furthermore, one of the advantages of a USF turbomachine compared to a Counter-Rotating Open Rotor turbomachine is that the tonal noise emitted by the turbomachine is reduced because the downstream stator blades 16, which are unducted, are not rotated about the longitudinal axis X.

The turbomachine 10 can have a Pusher configuration in which the annular row of upstream rotor blades 14 and the annular row of downstream stator blades 16 are located at a downstream end portion of the turbomachine 10 (the configuration shown in FIG. 1), or the turbomachine 10 can have a Puller configuration in which the annular row of upstream rotor blades 14 and the annular row of downstream stator blades 16 are located at an upstream end portion of the turbomachine 10.

In the Puller configuration, the annular row of upstream rotor blades 14 and the annular row of downstream stator blades 16 can surround a section of the compressor(s) 2 of the turbomachine or the gearbox. In the Pusher configuration, the annular row of upstream blades 14 and the annular row of downstream stator blades 14 can surround a section of the turbine(s) 6 of the turbomachine 10.

The absence of fairing leads to an increase in the noise level emitted by the turbomachine 10. This is because the noise generated by the annular rows of upstream rotor blades 14 and of downstream stator blades 16, unducted, is propagated in the free field. A main cause of the noise emitted is related, firstly, to the interaction of the wake of the upstream rotor blades 14 on the downstream stator blades 16, and, secondly, to vortex structures generated in the airflow at the free radially outer ends of the upstream rotor blades 14 which impact on the downstream stator blades 16.

However, too much noise is detrimental to the comfort of the passengers of the aircraft on which the turbomachine is installed. In addition, current standards impose a maximum noise threshold, particularly in the area close to the ground, i.e. during the take-off and landing phases.

Furthermore, when the upstream airflow perceived by the turbomachine 10 is not parallel to the longitudinal axis X (in particular during the landing and take-off phases), the forces generated on each upstream rotor blade 14 vary according to the position around the longitudinal axis X of the upstream rotor blade 14 during its rotation around the longitudinal axis X. Thus the directivity of the far field acoustic radiation is not axisymmetric. Also, the incidence of the airflow perceived by the turbomachine 10 is modified by the upstream propeller heterogeneously around the longitudinal axis X. As a result, the aerodynamic load applied to each of the downstream stator blades 16 differs depending on the position around the longitudinal axis X of the downstream stator blade 16, which can lead to unsatisfactory thrust provided by the downstream propeller during phases of operation at incidence of the turbomachine 10, in particular during the landing and take-off phases.

Furthermore, in operation, the presence of aircraft structural elements (mast, fuselage, wing, slat, flaps, etc.) located in the vicinity of the downstream propeller can modify the airflow conditions (pressure, longitudinal component of the flow velocity, etc.) locally around the longitudinal axis X, at the level of the annular row of downstream stator blades 16. However, a heterogeneous airflow around the longitudinal axis X at the downstream propeller also has the disadvantage of causing an aerodynamic load applied to each of the downstream stator blades 16 which differs depending on the position around the longitudinal axis X of the downstream stator blade 16.

### SUMMARY OF THE INVENTION

An aeronautical thruster of longitudinal axis is proposed comprising a hub, an annular row of unducted upstream rotor blades and an annular row of unducted downstream stator blades, the annular row of upstream rotor blades and the annular row of downstream stator blades being spaced apart along the longitudinal axis, wherein the annular row of downstream stator blades comprises:
at least one downstream stator blade of a first type, each downstream stator blade of the first type being located around the longitudinal axis in a first angular sector around the longitudinal axis, each downstream stator blade of the first type having a fixed pitch, —at least one downstream stator blade of a second type, each downstream stator blade of the second type being located around the longitudinal axis outside of said first angular sector, each downstream stator blade of the second type having a variable pitch.

Due to the fixed pitch of each of the downstream stator blades of the first type, the space requirement for each of the downstream stator blades of the first type at the hub is reduced, allowing the integration of ancillary thruster equipment into the hub at the first angular sector.

Each downstream stator blade of the second type can be rotated about a respective pitch axis to change the angle of incidence of the airflow on the downstream stator blade of the second type. The rotational adjustment of each downstream stator blade of the second type about the respective pitch axis can be made as a function of the phase of operation of the aeronautical thruster (i.e. in particular the landing phase and/or the take-off phase), and/or as a function of the airflow conditions taken locally at the downstream stator blade. The local airflow conditions at each downstream stator blade can depend, depending on the position of the downstream stator blade around the longitudinal axis, on the wake of the upstream rotor blades and/or on the presence of structural elements of an aircraft on which the aeronautical thruster is mounted (mast, fuselage, wing, slat, flaps, etc.). This firstly, reduces the noise level of the aeronautical thruster and secondly, improves the aerodynamic performance of the annular row of downstream stator blades.

The annular row of upstream rotor blades is rotatable about the longitudinal axis. The annular row of downstream stator blades is locked in rotation about the longitudinal axis. The annular row of downstream stator blades is therefore fixed around the longitudinal axis. In other words, the downstream stator blades are not rotated around the longitudinal axis.

The term “unducted” used in reference to the upstream rotor blades and downstream stator blades indicates that the upstream rotor blades and downstream stator blades are not surrounded by a basket, unlike conventional aeronautical thrusters where the fan is ducted within a basket.

The annular row of upstream rotor blades and the annular row of downstream stator blades can define an upstream propeller and a downstream propeller respectively. The annular row of downstream stator blades can be a rectifier.

Each blade (upstream and/or downstream) can extend radially. Each blade can extend between a radially inner end, which is located at (i.e. closest to the) hub of the aeronautical thruster, and a radially outer end. The radially inner end can be longitudinally at a leading edge of the blade or at the pitch axis of the blade considered. The radially inner end is also called the “root” of the blade. A position of each blade about the longitudinal axis can be identified by the position about the longitudinal axis of the radially inner end of the respective blade. The radially outer end of each blade is the opposite end of the radially inner end of the blade. The radially outer end can be the free end of the blade. The radially inner end and the radially outer end of each blade can be radially aligned and/or at the same longitudinal position. It is not excluded that the radially inner end and the radially outer end of each of the blades can be longitudinally and/or circumferentially offset from each other.

The position of each of the blades (upstream and/or downstream) about the longitudinal axis can be expressed as an angular position about the longitudinal axis. The angular position of each of the blades (upstream and/or downstream) can be marked in relation to a time dial (here seen from upstream for example) whose angular positions at 12H, 3H, 6H, 9H are positioned in a conventional manner. The angular position at 12H is therefore positioned vertically upwards with respect to the longitudinal axis. The angular position at 6H is positioned vertically downwards with respect to the longitudinal axis. The angular position at 3H is positioned horizontally towards the right with respect to the longitudinal axis. The angular position at 9H is positioned horizontally towards the left with respect to the longitudinal axis. An axis extending radially through the angular positions at 12H and 6H is thus perpendicular to an axis extending radially through the angular positions at 3H and 9H. Absolute positional qualifiers, such as “up”, “down”, “left”, “right”, etc., or relative positional qualifiers, such as “above”, “below”, “upper”, “lower”, etc., and orientation qualifiers, such as “vertical” and “horizontal”, can be considered in an operational state of the aeronautical thruster, typically when installed on a grounded aircraft. In this state of the aeronautical thruster, the axis through the angular positions at 12H and 6H extends in the direction of the gravity field, i.e. vertically.

The angular position of each blade (upstream and/or downstream) can be defined by an angle measured around the longitudinal axis positively clockwise from the angular position at 12H. The angle can be measured between an axis perpendicular to the longitudinal axis of the aeronautical thruster passing through the radially inner end (or radially outer end) of the downstream stator blade and the axis passing through the angular positions at 12H and 6H. Thus, the angular position of a blade located at the angular position at 12H can be defined by an angle equal to 0°, the angular position of a blade located at the angular position at 3H can be defined by an angle equal to 90°, the angular position of a blade located at the angular position at 6H can be defined by an angle equal to 180° (or equivalently −180°) and the angular position of a blade located at the angular position at 9H can be defined by an angle equal to 270° (or equivalently −90°).

Each blade has a radially outer radius. The radially outer radius of a blade can be taken as the radial distance to the longitudinal axis of the radially outer end of the blade. In other words, it is the maximum radius of the blade. The maximum radially outer radius among the annular row of upstream rotor blades is the radially outer radius of the upstream propeller. Each upstream rotor blade can have an identical radially outer radius. In this case, the radially outer radius of each upstream rotor blade corresponds to the radially outer radius of the upstream propeller. The maximum radially outer radius among the annular row of downstream stator blades is the radially outer radius of the downstream propeller. Each downstream stator blade can have an identical radially outer radius. In this case, the radially outer radius of each downstream stator blade corresponds to the radially outer radius of the downstream propeller. The annular row of stator blades can comprise two stator blades (possibly circumferentially consecutive) which have a different radially outer radius from each other. Independently or in combination, the annular row of stator blades can comprise two stator blades (possibly circumferentially consecutive) which have a different radially inner radius from each other.

Each blade (upstream and/or downstream) can have an aerodynamic profile. For this purpose, each blade can comprise a stack of sections in the radial direction. For each blade, a stacking line can be defined that passes through the centre of gravity of each blade section. It is not impossible that the stacking line of one or more blades forms a non-linear curve. In one particular case, the stacking line of one or more blades can extend radially in a straight line. Each section extends in a respective section plane which is perpendicular to the radial direction of extension of the corresponding blade. Each section can comprise an upstream leading edge and a downstream trailing edge, between which extend a lower surface line (“intrados” line) and upper surface line (“extrados” line). Each section can define an aerodynamic profile. Each section can comprise a chord defined by a straight line portion connecting the leading edge to the trailing edge. When reference is made to the aerodynamic profile of a section or blade, this means the two-dimensional shape of the section, or respectively the three-dimensional shape of the blade, irrespective of the blade pitch angle or the angular position of the blade around the longitudinal axis.

The leading edge and trailing edge of all the sections in the stack of sections can form a leading edge and trailing edge of the blade respectively. Similarly, the lower surface line and upper surface line of all the sections in the section stack can form a lower surface face (“intrados” face) and an upper surface face (“extrados” face) of the downstream stator blade, respectively, for each blade. Regardless of the pitch configuration of each of the downstream stator blades, the lower surface face and the upper surface face can be positioned in the same direction in the circumferential direction with respect to each other.

Each stator blade (of the first and second type) has a respective pitch axis. The pitch axis of each downstream stator blade can lie in a plane perpendicular to the longitudinal axis. In other words, the pitch axis of each downstream stator blade can extend in a direction with a zero longitudinal component. The pitch axis of each downstream stator blade can extend radially. It is not excluded that the pitch axis comprises a radial component and/or a longitudinal component and/or a circumferential component.

The pitch angle of each downstream stator blade can correspond to the angle formed between, firstly, a first axis which is defined by the intersection between the cross-sectional plane of a reference section among the stack of sections of the blade and a plane perpendicular to the longitudinal axis (which can include the pitch axis of the downstream stator blade), and, secondly, the chord of the reference section of the downstream stator blade. The angle can be measured on the upstream side of the plane perpendicular to the longitudinal axis. The angle can be measured positively in a direction from the first axis to the chord of the reference section, and more particularly in a direction coinciding with the direction from the lower surface line to the upper surface line.

A first downstream stator blade can be said to be “closed pitch” relative to a second downstream stator blade when it has a pitch angle smaller than the pitch angle of the second downstream stator blade, preferably by at least 0.1°, more preferably by at least 1°. Conversely, a first downstream stator blade can be said to be “open pitch” relative to a second downstream stator blade when it has a pitch angle greater than the pitch angle of the second downstream stator blade, preferably at least 0.1°, more preferably at least 1°.

Each downstream stator blade of the second type can be pivotally mounted about the respective pitch axis which extends in a direction that includes at least a radial component. The aeronautical thruster can further comprise means for independently or together driving each of the downstream stator blades of the second type in rotation about the respective pitch axis. For example, the aeronautical thruster can comprise means for driving together each of the downstream stator blades of the second type which are disposed in a second angular sector about the longitudinal axis, distinct from the first angular sector, in rotation about the respective pitch axis. In particular, each downstream stator blade of the second type can be connected at its radially inner end to a pitch arm which is adapted to rotate about the pitch axis of the downstream stator blade of the second type.

The reference section of each downstream stator blade can be located at the radially inner end of the downstream stator blade. Alternatively, the reference section of each downstream stator blade can be located, on the corresponding downstream stator blade, at a radial distance from the longitudinal axis which corresponds to 75% of the radially outer radius of the corresponding downstream stator blade. Alternatively again, the reference section of each downstream stator blade can be located, on the downstream stator blade, at a radial distance from the longitudinal axis which corresponds to 75% of the radially outer radius of the downstream stator blade that has the minimum radially outer radius among the annular row of downstream stator blades.

The aeronautical thruster can comprise between 2 and 25 upstream rotor blades. The aeronautical thruster can comprise between 2 and 25 downstream stator blades. The aeronautical thruster can comprise between 1 and 6 downstream stator blades of the first type. The aeronautical thruster can preferably comprise 2 downstream stator blades of the first type.

The number of upstream rotor blades can be different from the number of downstream stator blades. This reduces the number of upstream rotor blades that are simultaneously positioned circumferentially around the longitudinal axis longitudinally opposite one of the downstream stator blades. This reduces the number of wakes of upstream rotor blades that interact simultaneously with the downstream stator blades. The noise emitted by the propeller is then reduced. In particular, the number of upstream rotor blades can be greater than the number of downstream stator blades. Each downstream stator blade is a source of noise emission, and so a reduced number of downstream stator blades further reduces the noise level emitted by the thruster.

The strength of the annular row of downstream stator blades, defined as the ratio of the chord to the spacing in the circumferential direction between two circumferentially consecutive downstream stator blades, can be less than or equal to 3 over the entire radial dimension of each downstream stator blade. In particular, in a preferred embodiment, the strength is less than or equal to 1 at a radially outer end of each downstream stator blade.

Similarly, the strength of the annular row of upstream rotor blades, defined as the ratio between the chord, and the spacing in the circumferential direction between two circumferentially consecutive upstream rotor blades, can be less than or equal to 3 over the whole of the radial dimension of each upstream rotor blade. In particular, in a preferred embodiment, the strength is less than or equal to 1 at a radially outer end of each upstream rotor blade.

The ratio between, firstly, the distance in the longitudinal direction separating a median plane of the upstream annular row of rotor blades and a median plane of the downstream annular row of stator blades, and, secondly, the diameter of the aeronautical thruster can vary between 0.01 and 0.8, preferably between 0.1 and 0.5. The median plane of each annular row of blades can be normal to the longitudinal axis. The median plane of each annular row of blades can be the plane containing the pitch axis of each of the blades in the corresponding annular row. Alternatively, the median plane of each annular row of blades can be the plane containing the pitch axis of at least one of the blades of the corresponding annular row. The diameter of the aeronautical thruster can be defined as twice the radially outer radius of the upstream propeller. The trailing edge of each of the blades in the upstream annular row is located longitudinally upstream of a leading edge of each of the blades in the downstream annular row. This limits or even avoids interferences between annular rows of blades.

The hub can be axisymmetric about the longitudinal axis.

The first angular sector can extend over an angular range of less than or equal to 180°, preferably less than or equal to 120°, more preferably less than or equal to 60°.

At least two downstream stator blades of the first type can have an identical pitch angle. This simplifies the manufacture of the aeronautical thruster. Each downstream stator blade of the first type can have an identical pitch angle.

At least two downstream stator blades of the first type can have a different pitch angle. The two said downstream blades of the first type can be circumferentially consecutive.

The difference between the pitch angle of two downstream stator blades of the first type can be less than 120°, preferably less than 60°. The difference between the pitch angle of two circumferentially consecutive downstream stator blades of the first type can be less than 45°, preferably less than 15°.

The pitch angle of each downstream stator blade of the first type can be determined as a function of the angular position of the downstream stator blade of the first type about the longitudinal axis, in particular according to a linear, parabolic, sinusoidal, logarithmic, or exponential law.

Each downstream stator blade of the first type can have identical dimensional characteristics. This simplifies the manufacture of the aeronautical thruster. At least two downstream stator blades of the first type can have identical dimensional characteristics. It is understood that for each section of one of the two downstream stator blades, there is a corresponding section of the other of the two downstream stator blades which is arranged at the same radial distance from the longitudinal axis and has the same aerodynamic profile.

At least two downstream stator blades of the first type may have different dimensional characteristics. It is understood that for each section of one of the two downstream stator blades, there is a corresponding section of the other of the two downstream stator blades which is arranged at the same radial distance from the longitudinal axis and has the same aerodynamic profile.

The annular row of downstream stator blades can comprise a first set and a second set of downstream stator blades of the first type, each downstream stator blade of the first type of the first set having identical first dimensional characteristics and each downstream stator blade of the first type of the second set having identical second dimensional characteristics.

Alternatively, at least two downstream stator blades have identical dimensional characteristics on an upstream end portion that extends longitudinally over a relative chord length of between 2% and 50%, preferably between 10% and 30%. In other words, for each section of one of the two downstream stator blades, there is a corresponding section of the other of the two downstream stator blades which is arranged at the same radial distance from the longitudinal axis and which has the same aerodynamic profile over a relative chord length of the section of between 2% and 50%, preferably between 10% and 30%. This reduces the manufacturing costs of the aeronautical thruster and ensures homogeneity at the leading edge of the downstream stator blades, which is beneficial in reducing the tonal interaction noise of the aeronautical thruster.

At least two downstream stator blades of the second type can have a different pitch angle. The two said downstream blades of the second type can be circumferentially consecutive. At least two downstream stator blades of the second type can have an identical pitch angle.

The difference between the pitch angle of two downstream stator blades of the second type can be less than 120°, preferably less than 60°. The difference between the pitch angle of two circumferentially consecutive downstream stator blades of the second type can be less than 20°, preferably less than 15°.

The difference between the pitch angle of two circumferentially consecutive downstream stator blades of the second type can be smaller than the difference between the pitch angle of two circumferentially consecutive downstream stator blades of the first type.

The pitch angle of each downstream stator blade of the second type can be determined as a function of the angular position of the downstream stator blade of the second type about the longitudinal axis, in particular according to a linear, parabolic, sinusoidal, logarithmic, or exponential law.

Each downstream stator blade of the second type can have a different pitch angle to the pitch angle of circumferentially adjacent downstream stator blades of the second type. This reduces the correlation of noise sources and thus reduces the level of noise emitted by the aeronautical thruster.

Each downstream stator blade of the second type can have identical dimensional characteristics. The annular row of stator blades can comprise a first group of downstream stator blades of the second type each having a first pitch angle and a second group of downstream stator blades of the second type each having a second pitch angle different from the first pitch angle. The first group of downstream stator blades of the second type and the second group of downstream stator blades of the second type can each comprise at least two circumferentially adjacent downstream stator blades of the second type.

In another aspect, a propulsion assembly for an aircraft is proposed, the propulsion assembly comprising an aeronautical thruster as described above and a pylon for attaching the aeronautical thruster to the aircraft, the pylon extending in a direction comprising at least one radial component from a radially inner end by which the pylon is connected to the hub of the aeronautical thruster, the first angular sector being centred on a longitudinal median plane of the pylon.

Due to the fixed pitch of each of the downstream stator blades of the first type, the space requirement associated with each of the downstream stator blades of the first type at the hub is reduced, allowing the incorporation into the hub at the first angular sector of means of attachment to attach the pylon to the hub of the thruster.

The pylon can comprise a leading edge and a trailing edge between which extend on each side in the circumferential direction a upper surface face and a bottom face, the upper surface face and the lower surface face of the pylon being, at least on an upstream part of the pylon arranged circumferentially on either side of a radial plane defined by the longitudinal axis and a radial axis passing, at least in part, through the leading edge of the pylon, the annular row of downstream stator blades of the aeronautical thruster comprising:
a first group comprising one or more downstream blades of the first type which each have a downstream end located circumferentially on the same side as the upper surface face of the pylon with respect to the radial plane, the first group comprising at least the downstream stator blade of the first type which is circumferentially closest to the radial plane and whose downstream end is located circumferentially on the same side as the upper surface face of the pylon with respect to the radial plane
a second group comprising one or more downstream blades of the first type which each have a downstream end located circumferentially on the same side as the lower surface face of the pylon with respect to the radial plane, the second group comprising at least the downstream stator blade of the first type which is circumferentially closest to the radial plane and whose downstream end is located circumferentially on the same side as the lower surface face of the pylon with respect to the radial plane.

Each downstream stator blade of the first type of the first group can be in a closed-pitch configuration relative to the downstream stator blades of the first type of the second group.

Such an arrangement facilitates the bypassing of the airflow around the pylon, thereby reducing pressure distortion rise between the pylon and the downstream stator blades of the first type, and avoiding boundary layer separation and the formation of recirculation zones on the downstream stator blades of the first type which would increase aerodynamic losses and noise levels.

The “lower surface face” and “upper surface face” of the pylon means the end faces of the pylon in the circumferential direction, these being positioned in the same direction in the circumferential direction as the lower surface and upper surface faces of each of the downstream stator blades. The pylon can have a shape that does not have an aerodynamic profile. The pylon can have a symmetrical shape with respect to a longitudinal plane (i.e. including at least the longitudinal axis).

In other words, each downstream stator blade of the first type of the second group is in an open-pitch configuration relative to the downstream stator blades of the first type of the first group. Alternatively, each downstream stator blade of the first type of the first group can be in the closed-pitch configuration relative to the downstream stator blades of the second type and each downstream stator blade of the first type of the second group can be in the open-pitch configuration relative to the downstream stator blades of the second type.

The pylon can be connected to one of the downstream stator blades to form a unitary aerodynamic assembly. This reduces the drag forces associated with the pylon.

The pylon can be positioned around the axis of rotation at an angular position at 12H or 6H around the longitudinal axis of the aeronautical thruster. Such a configuration allows the aeronautical thruster to be attached to or under the aircraft's wing.

The pylon can be positioned around the axis of rotation at an angular position at 3H or 9H around the longitudinal axis of the aeronautical thruster. Such a configuration allows the aeronautical thruster to be attached to a rear part of an aircraft fuselage.

The pylon can be arranged longitudinally, in whole or in part, downstream of the annular row of downstream stator blades.

The pylon can be arranged circumferentially, in whole or in part, between two circumferentially adjacent downstream stator blades of the first type.

In another aspect, an aircraft is proposed comprising an aeronautical thruster as described above or a propulsion system as described above.

In a further aspect, it is proposed a method of operating the aeronautical thruster as described above or the propulsion system as described above, the method comprising adjusting the pitch angle of each downstream stator blade of the second type in accordance with an incidence phase of operation of the aeronautical thruster.

A phase of impact operation can be characterised by one or more of the following features:
one Mach of advancement of the propulsion system between 0 and 0.4;
the propulsion system comprises a high-lift device (slat, flap) in an at least partially deployed state;
the altitude of the thruster system is less than or equal to 5000 m;
the slope of the trajectory of the propulsion system is between −1° and −10° (landing incidence phase) or between 1° and 20° (take-off incidence phase);
the propulsion system is attached to an aircraft whose angle of attack (i.e. the angle between the forward speed and the main axis of an aircraft fuselage) is between 0° and 10° (landing incidence phase) or between 0° and 15° (take-off incidence phase).

The method can include sensing one or more of the foregoing characteristics and transmitting the characteristic(s) as data to a digital control system (e.g. an interface between a cockpit and the engine, known as “Full Authority Digital Engine Control”, also known as “FADEC”). The determination of the pitch angle of each downstream stator blade of the second type can be achieved by servo-control of said data, in particular by the digital control system.

### BRIEF DESCRIPTION OF THE DRAWINGS

Further features, details and benefits will emerge from reading the detailed description below, and from the analysis of the attached drawings, on which:

FIG. 1 is a partial schematic cross-sectional view of an unducted fan turbomachine according to the prior art;

FIG. 2 is a partial schematic cross-sectional view of an unducted turbomachine according to the present description;

FIG. 3 includes FIG. 3a which is a schematic view of a downstream stator blade of the turbomachine of FIG. 2 and FIG. 3b which is a schematic view of the downstream stator blade in FIG. 3 in section plane III-III;

FIG. 4 comprises FIGS. 4a and 4b which are respectively a schematic perspective view and a schematic cross-sectional view of an annular row of downstream stator blades of the turbomachine of FIG. 2;

FIG. 5 is a circumferentially extended schematic partial view of a first configuration of the annular row of downstream stator blades of FIG. 4;

FIG. 6 comprises FIGS. 6a to 6c, each of which represents a graph illustrating a variant of the first configuration of the annular row of downstream stator blades of FIG. 5;

FIG. 7 is a circumferentially extended schematic partial view of a second configuration of the annular row of downstream stator blades of FIG. 4;

FIG. 8 comprises FIG. 8a and FIG. 8b, each of which is a circumferentially extended schematic partial view of a variant of a third configuration of the annular row of downstream stator blades of FIG. 4;

FIG. 9 comprises FIG. 9a which is a circumferentially extended diagrammatic partial view of a fourth configuration of the annular row of downstream stator blades of FIG. 4 and FIG. 9b which represents an embodiment detail of the fourth configuration of the annular row of downstream stator blades;

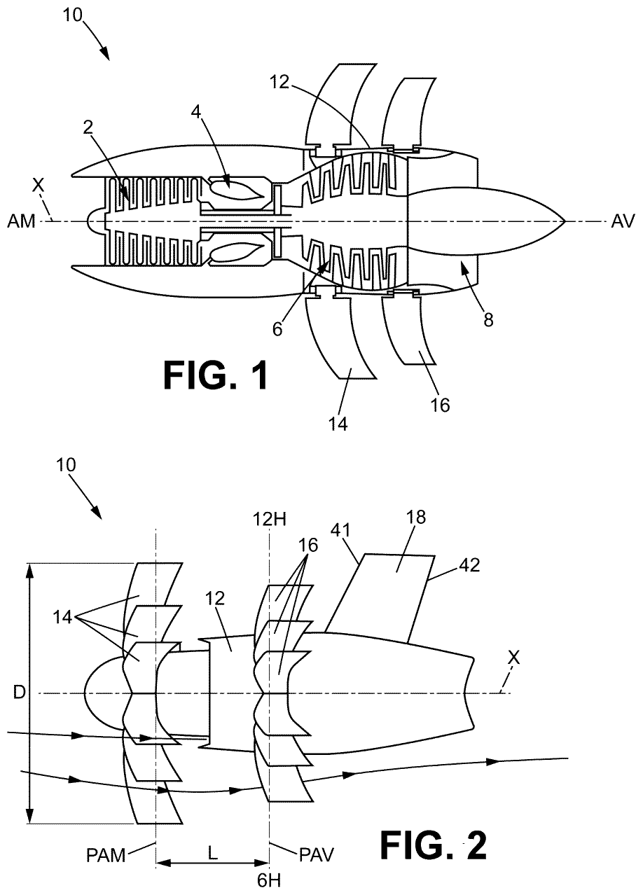

### DESCRIPTION OF THE EMBODIMENTS

Reference is now made to FIG. 2. FIG. 2 shows a propulsion system for an aircraft which comprises a turbomachine 10 of longitudinal axis X and a pylon 18 adapted to attach the turbomachine 10 to the aircraft, here at a wing of the aircraft. Alternatively, the pylon 18 can be adapted to attach the turbomachine 10 to a fuselage, in particular aft, of the aircraft. As before, orientation qualifiers such as “longitudinal”, “radial” or “circumferential” are defined with reference to the longitudinal axis X of the turbomachine 10. The relative terms “upstream” and “downstream” are defined in relation to each other with reference to the flow of gases in the turbomachine 10 along the longitudinal axis X.

The turbomachine 10 comprises a hub 12. The hub 12 is here axisymmetric about the longitudinal axis X. The turbomachine 10 further comprises an annular row of unducted upstream rotor blades 14 and an annular row of unducted downstream stator blades 16. The annular row of upstream rotor blades 14 and the annular row of downstream stator blades 16 are spaced apart from each other along the longitudinal axis X. The term “unducted” used in reference to the upstream rotor blades 14 and the downstream stator blades 16 indicates that the upstream rotor blades 14 and the downstream stator blades 16 are not surrounded by a basket, in contrast to conventional turbomachines 10 in which the fan is ducted within a basket.

The annular row of upstream rotor blades 14 is rotatable about the longitudinal axis X. The annular row of downstream stator blades 16, which are unducted, is prevented from rotating about the longitudinal axis X. The annular row of downstream stator blades 16 is therefore fixed about the longitudinal axis X. In other words, the downstream stator blades 16 are not rotated about the longitudinal axis X. The annular row of upstream rotor blades 14 and the annular row of downstream stator blades 16 define an upstream propeller and a downstream propeller respectively.

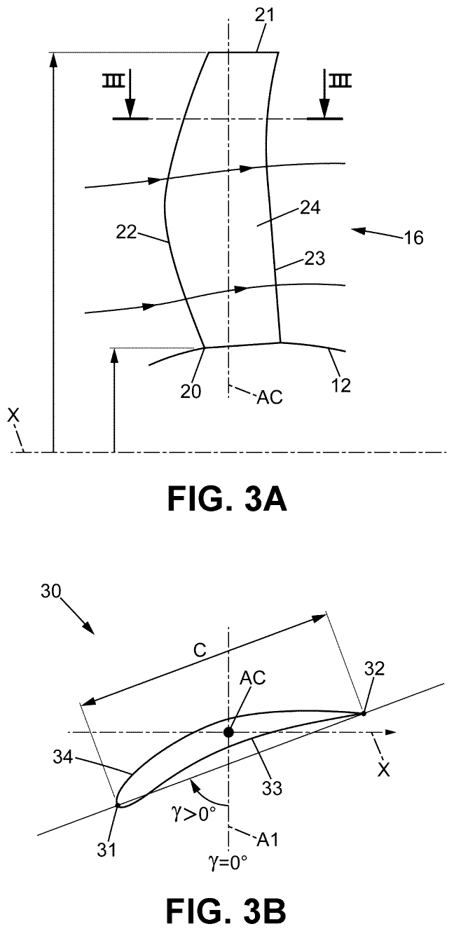

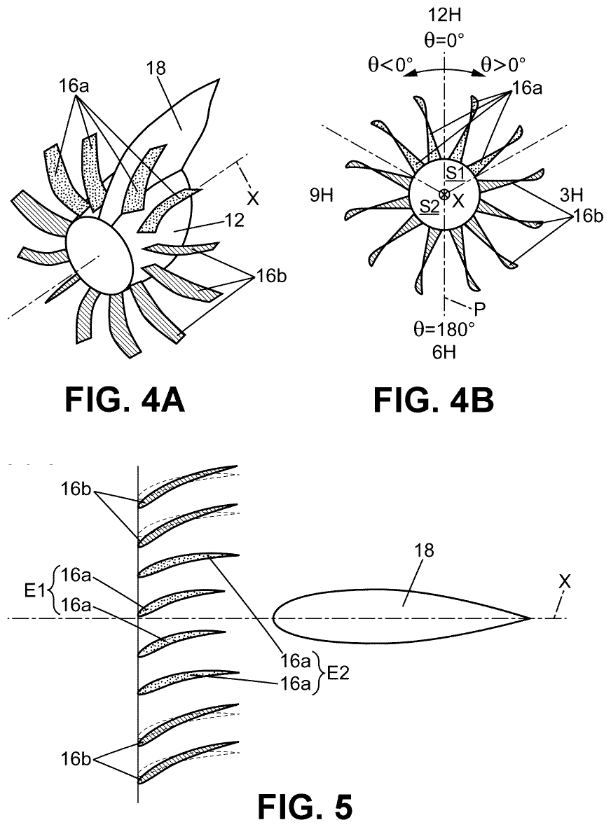

FIG. 4 shows the annular row of downstream stator blades 16 and FIG. 3 shows one of the downstream stator blades 16 in more detail. Each downstream stator blade extends radially between a radially inner end 20, this being located at (i.e. closest to) the hub 12 of the turbomachine 10, and a radially outer end 21. In the example shown, the radially inner end 20 is longitudinally at a leading edge 22 of the blade. The radially inner end 20 is also called the “root” of the blade. The position of each blade about the longitudinal axis X as considered hereafter is marked by the position about the longitudinal axis X of the radially inner end 20 of the respective blade. The radially outer end 21 of each downstream stator blade 16 is the opposite end to the radially inner end 20 of the blade. The radially outer end 21 is the free end of the downstream stator blade 16.

The position of each of the downstream stator blades 16 about the longitudinal axis X is expressed as an angular position about the longitudinal axis X. The angular position of each of the downstream stator blades 16 is referenced to a time dial (here considered from upstream for example) whose angular positions at 12H, 3H, 6H and 9H are conventionally positioned. The angular position at 12H is therefore positioned vertically upwards with respect to the longitudinal axis X. The angular position at 6H is positioned vertically downwards with respect to the longitudinal axis X. The angular position at 3H is positioned horizontally to the right with respect to the longitudinal axis X. The angular position at 9H is positioned horizontally to the left with respect to the longitudinal axis X. An axis extending radially through the angular positions at 12H and 6H is thus perpendicular to an axis extending radially through the angular positions at 3H and 9H. Qualifiers of absolute position, such as the terms “top”, “bottom”, “left”, “right”, etc., or of relative position, such as the terms “above”, “below”, “upper”, “lower”, etc., and the orientation qualifiers, such as the terms “vertical” and “horizontal” can be considered in an operational state of the turbomachine 10, typically when the latter is installed on an aircraft on the ground. In this state of the turbomachine 10, the axis through the angular positions at 12H and 6H extends in the direction of the gravity field, i.e. vertically.

The angular position of each downstream stator blade 16 is also defined by an angle θ measured around the longitudinal axis X positively clockwise from the angular position at 12H. For example, for each downstream stator blade 16, the angle θ can be measured between an axis perpendicular to the longitudinal axis X of the turbomachine 10 passing through the radially inner end 20 (or radially outer end 21) of the downstream stator blade 16 and the axis passing through the angular positions at 12H and 6H. Thus, the angular position of a downstream stator blade 16 located at the angular position at 12H is defined by an angle θ equal to 0°, the angular position of a downstream stator blade 16 located at the angular position at 3H is defined by an angle θ equal to 90°, the angular position of a downstream stator blade 16 located at the angular position at 6H is defined by an angle θ equal to 180° (or equivalently −180°) and the angular position of a downstream stator blade 16 located at the angular position at 9H is defined by an angle θ equal to 270° (or equivalently −90°).

Each downstream stator blade 16 has a radially outer radius. The radially outer radius of a blade is the radial distance to the longitudinal axis X of the radially outer end 21 of the blade. In other words, it is the maximum radius of the blade. In the example shown, each downstream stator blade 16 has an identical radially outer radius which thus corresponds to the radially outer radius of the downstream propeller.

Each downstream stator blade 16 defines an aerodynamic profile. For this purpose, each downstream stator blade 16 comprises a stack of sections 30 in the radial direction. One of the sections 30 is shown in FIG. 3b. Each section 30 extends in a respective section plane which is perpendicular to the radial direction of extension of the corresponding downstream stator blade 16. Each section 30 comprises an upstream leading edge 31 and a downstream trailing edge 32, between which a lower surface line 33 and an upper surface line 34 extend. Each section 30 defines an aerodynamic profile. Each section 30 also includes a C chord defined by a straight line portion connecting the leading edge 31 to the trailing edge 32.

The leading edge 31 and the trailing edge 32 of all the sections 30 in the stack of sections 30 form, for each downstream stator blade 16, a leading edge 22 and a trailing edge 23 of the blade respectively. Similarly, the lower surface line 33 and the upper surface line 34 of the set of sections 30 of the stack of sections 30 respectively form, for each downstream stator blade 16, a lower surface face 24 (visible in FIG. 3a) and an upper surface face (not visible in FIG. 3a) of the downstream stator blade 16.

Each downstream stator blade 16 has a respective AC pitch axis. As can be seen in FIG. 3a, the pitch axis AC of each downstream stator blade 16 here lies in a plane perpendicular to the longitudinal axis X. In particular, the pitch axis AC of each downstream stator blade 16 extends radially in the illustrated example.

As shown in FIG. 3b, the pitch angle γ of each downstream stator blade 16 corresponds to the angle formed between a first axis A1 which is defined by the intersection between the section plane of a reference section 30 among the stack of sections 30 of the downstream stator blade 16 and a plane perpendicular to the longitudinal axis X which includes the pitch axis AC of the downstream stator blade 16, and, secondly, the chord C of the reference section 30 of the downstream stator blade 16. The pitch angle γ is measured on the upstream side of the plane perpendicular to the longitudinal axis X which includes the pitch axis AC of the downstream stator blade 16. The pitch angle γ is measured positively in a direction from the first axis A1 to the chord C of the reference section 30, and more particularly in a direction coinciding with the direction from the lower surface line 33 towards the upper surface line 34.

The reference section 30 of each downstream stator blade 16 is located here, on the corresponding downstream stator blade 16, at a radial distance to the longitudinal axis X which corresponds to 75% of the radially outer radius of the corresponding downstream stator blade 16.

In the following, a first downstream stator blade 16 is said to be “closed pitch” relative to a second downstream stator blade 16 when it has a pitch angle less than the pitch angle of the second downstream stator blade 16. In the following, a first downstream stator blade 16 is said to be “closed pitch” relative to a second downstream stator blade 16 when it has a pitch angle less than the pitch angle of the second downstream stator blade 16.

Regardless of the pitch configuration of each of the downstream stator blades 16, the lower surface face 24 and the upper surface face are, for each of the downstream stator blades 16, positioned relative to each other according to the same direction in the circumferential direction.

The strength of the annular row of downstream stator blades 16, defined as the ratio of the chord to the spacing in the circumferential direction between two circumferentially consecutive downstream stator blades 16, can be less than or equal to 3 over the entire radial dimension of each downstream stator blade 16. In particular, in a preferred embodiment, the strength is less than or equal to 1 at a radially outer end 21 of each downstream stator blade 16.

The ratio between, on the one hand, the distance L in the longitudinal direction separating a median plane PAM of the annular row of upstream rotor blades 14 and a median plane PAV of the annular row of downstream stator blades, and on the other hand, the diameter D of the turbomachine 10 can vary between 0.01 and 0.8, preferably between 0.1 and 0.5. The median plane PAM, PAV of each annular row of blades is here normal to the longitudinal axis X. The median plane PAM, PAV of each annular row of blades is the plane containing the pitch axis AC of each of the blades of the corresponding annular row. The diameter D of the turbomachine 10 corresponds here to the diameter of the upstream propeller. The trailing edge of each of the blades in the upstream annular row 14 is located longitudinally upstream of a leading edge 22 of each of the blades in the downstream annular row 16. This limits or even avoids interference between annular rows of blades.

The pylon 18 has a radially inner end 20 through which it is connected to the hub 12 of the turbomachine 10. The pylon 18 extends generally radially in that it extends in a direction comprising at least a radial component. It is not excluded that the pylon 18 extends in a direction that also includes a longitudinal and/or circumferential component. In the example shown in FIG. 2, the pylon extends in a direction comprising a radial and a longitudinal component. The pylon 18 comprises a leading edge 41 and a trailing edge 42, between which an upper surface face 44 and an lower surface face 43 extend on each side in the circumferential direction. The upper surface face 44 and the lower surface face 43 of the pylon 18 are, at least on an upstream part of the pylon 18, arranged circumferentially on each side of a radial plane defined by the longitudinal axis X and a radial axis passing through the leading edge 41 of the radially inner end of the pylon 18. In the example shown, the pylon 18 has an aerodynamic profile.

In the example shown in FIG. 2, the pylon 18 is positioned about the axis of rotation at an angular position at 12H about the longitudinal axis X of the turbomachine 10. Such a configuration allows the turbomachine 10 to be mounted under the wing of the aircraft. In the example shown in FIG. 3, the pylon 18 is arranged longitudinally downstream of the annular row of downstream stator blades 16. In the example shown in FIG. 4, the pylon 18 is arranged longitudinally partly downstream of the annular row of downstream stator blades 16. Indeed, in the example shown in FIG. 4, the pylon 18 is also arranged circumferentially, in part, between two circumferentially adjacent downstream stator blades 16.

As shown in FIG. 4, the annular row of downstream stator blades comprises:
a plurality of downstream stator blades of a first type 16a, each downstream stator blade of the first type 16a being located around the longitudinal axis X in a first angular sector S1 around the longitudinal axis X which is centred on a longitudinal median plane P of the pylon 18 each downstream stator blade of the first type 16a having a fixed pitch, and —a plurality of downstream stator blades of a second type 16b, each downstream stator blade of the second type 16b being located around the longitudinal axis X outside said first angular sector S1, each downstream stator blade of the second type 16b having a variable pitch.

Due to the fixed pitch of each of the downstream stator blades of the first type 16a, the space requirement associated with each of the downstream stator blades of the first type 16a at the hub 12 is reduced. This allows means of attachment to be incorporated into the hub 12 at the first angular sector S1 to secure the pylon 18 to the hub 12 of the turbomachine 10. In particular, these means can be arranged radially inside the hub. This also allows the integration of ancillary equipment of the turbomachine 10 on the means 12 at the first angular sector S1, such as elements of the control system like air and/or oil ducts, for example.

Each downstream stator blade of the second type 16b is pivotally mounted about the respective AC pitch axis. To this end, the turbomachine 10 can comprise means for independently or together driving each of the downstream stator blades of the second type 16b in rotation about the respective AC pitch axis. These means can be arranged radially inside the hub 12. In particular, each downstream stator blade of the second type 16b can be connected, at its radially inner end 20, to a pitch arm which is adapted to rotate around the pitch axis AC of the downstream stator blade of the second type 16b.

Each downstream stator blade of the second type 16b can thus be rotated around the respective pitch axis AC to change the angle of incidence of the air flow on the downstream stator blade of the second type 16b. The rotational adjustment of each downstream stator blade of the second type 16b about the respective pitch axis AC can be made as a function of the incidence of the turbomachine 10 and/or the operating points which vary according to the phase of operation of the aeronautical thruster (e.g. landing phase and/or take-off phase), and/or as a function of the airflow conditions taken locally at the downstream stator blade 16. The local airflow conditions at each downstream stator blade can depend, depending on the position of the downstream stator blade of the second type 16b about the longitudinal axis X, on the wake of the upstream rotor blades 14 and/or on the presence of structural elements of an aircraft on which the turbomachine 10 is mounted (mast, fuselage, wing, slat, flaps, etc). This makes it possible, firstly, to reduce the level of noise emitted by the turbomachine 10, and, secondly, to improve the aerodynamic performance of the annular row of downstream stator blades 16.

In the example shown, the annular row of stator blades comprises 4 downstream stator blades of the first type 16a. The first angular sector S1 is here centred on the angular position at 12H. The first angular sector S1 in which the stator blades of the first type 16a are arranged extends over an angular range of less than 120°. The annular row of stator blades further comprises 8 downstream stator blades of the second type 16b. The downstream stator blades of the second type 16b are each arranged in a second angular sector S2 which is distinct from the first angular sector S1. Here the first angular sector S1 and the second angular sector S2 are complementary in that they extend over angular ranges whose sum is equal to 360°. However, it is not excluded that the annular row of downstream stator blades comprises a further plurality of stator blades of the first type (i.e. fixed pitch) each located in a third angular sector around the longitudinal axis X which is distinct from the first angular sector S1 and the second angular sector S3.

FIG. 5 shows a first configuration of the annular row of downstream stator blades 16. In the first configuration, each downstream stator blade of the first type 16a has an identical pitch angle. This simplifies the manufacture of the propulsion system.

Furthermore, in the first configuration, the annular row of downstream stator blades comprises a first set E1 of downstream stator blades of the first type 16a and a second set E2 of downstream stator blades of the first type 16a. Each downstream stator blade of the first type 16a of the first assembly E1 has identical first dimensional characteristics (i.e. an identical first aerodynamic profile) and each downstream stator blade of the first type 16a of the second assembly E2 has identical second dimensional characteristics (i.e. an identical second aerodynamic profile). Furthermore, each downstream stator blade of the second type 16b has identical dimensional characteristics (i.e. an identical aerodynamic profile).

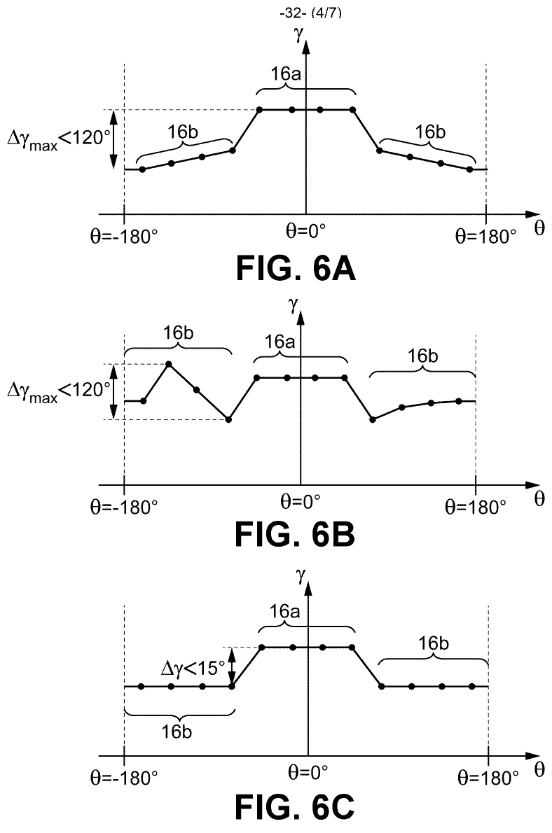

FIG. 6a is a graph showing a first variant of the first configuration of the downstream stator blade ring row. The graph shows the pitch angle γ of each of the downstream stator blades 16 as a function of the angle θ associated with the circumferential angular position of the blade about the longitudinal axis. In the first variant of the first configuration, each downstream stator blade of the second type 16b whose angular position is defined by an angle θ of between 0° and 180° has a pitch angle γ determined as a function of the angular position of the downstream stator blade of the second type 16b about the longitudinal axis X according to a linear law. Also, for each downstream stator blade of the second type 16b whose angular position is defined by an angle θ between 0° and 180°, the annular row of downstream stator blades comprises another downstream stator blade of the second type 16b angularly positioned around the longitudinal axis X at an angle—θ and having an identical pitch angle γ. This simplifies the design of the pitch change means and is beneficial for noise reduction, as the downstream stator blades 16 with a more closed pitch are located around the positions at 3H, 6H and 9H.

The difference between the pitch angle γ of two downstream stator blades can be less than 120°, preferably less than 60°. The difference between the pitch angle γ of two circumferentially consecutive downstream stator blades of the second type 16b can be less than 20°, preferably less than 15°.

FIG. 6b is a graph showing a first variant of the first configuration of the annular row of downstream stator blades. The graph also shows the pitch angle γ of each of the downstream stator blades as a function of the angle θ associated with the angular position of the blade. In the second variant of the first configuration, the pitch angle γ of each downstream stator blade of the second type 16b is different from the pitch angle γ of the other downstream stator blades of the second type, in particular so that the pitch angle γ of each downstream stator blade of the second type 16b is adapted to the incidence of the turbomachine 10 or to the flight point. Also, the pitch angle γ of each downstream stator blade of the second type 16b is different from the pitch angle γ of the circumferentially adjacent downstream stator blade(s) of the second type. This reduces the correlation of noise sources and thus reduces the level of noise emitted by the turbomachine 10.

FIG. 6b is a graph showing a first variant of the first configuration of the annular row of downstream stator blades. The graph shows the pitch angle γ of each of the downstream stator blades 16 as a function of the angle θ associated with the circumferential angular position of the blade about the longitudinal axis. In the third variant of the first configuration, the pitch angle γ of each downstream stator blade of the second type 16b is identical. This simplifies the design and makes the system for changing the pitch of the downstream stator blades of the second type 16b more robust.

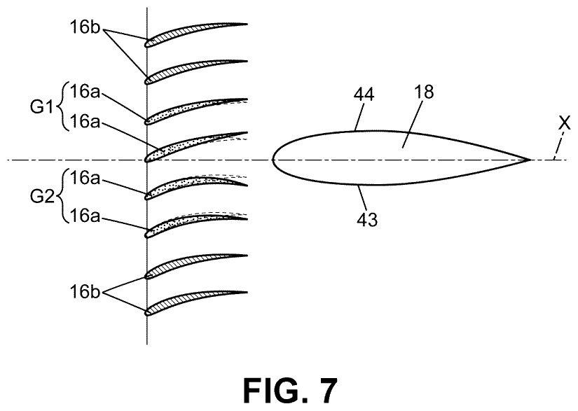

FIG. 7 shows a first configuration of the annular row of downstream stator blades. In the second configuration, the pitch angle γ of each downstream stator blade of the first type 16a is different from the pitch angle γ of the other downstream stator blades of the first type 16a. This allows certain dimensional characteristics of the stator blades of the first type 16a to be adapted to ensure that the airflow can bypass the pylon without degrading the aerodynamic behaviour (i.e. without separations, recirculation zones, etc.) around the stator blades of the first type 16a. This also reduces the level of noise emitted by the turbomachine 10.

The difference between the pitch angle γ of two downstream stator blades of the first type 16a can be less than 120°, preferably less than 60°. The difference between the pitch angle γ of two downstream stator blades of the first type 16a can be less than 45°, preferably less than 15°. The difference between the pitch angle γ of two circumferentially consecutive downstream stator blades of the second type 16b can be smaller than the difference between the pitch angle γ of two circumferentially consecutive downstream stator blades of the first type 16a.

The pitch angle γ of each downstream stator blade of the first type 16a can be determined as a function of the angular position of the downstream stator blade of the first type 16a about the longitudinal axis X, in particular according to a linear, parabolic, sinusoidal, logarithmic, or exponential law.

In particular, in the second configuration, the annular row of downstream stator blades comprises:
a first group G1 comprising two circumferentially adjacent downstream blades of the first type 16a which each have a downstream end located circumferentially on the same side of the radial plane as the upper surface face 44 of the pylon 18, the first group G1 comprising the downstream stator blade of the first type 16a which is circumferentially closest to the radial plane and whose downstream end is located circumferentially on the same side of the radial plane as the upper surface face 44 of the pylon 18 with respect to the radial plan,
a second group G2 comprising two circumferentially adjacent downstream blades of the first type 16a which each have a downstream end located circumferentially on the same side as the lower surface face 43 of the pylon 18 with respect to the radial plane, the second group G2 comprising the downstream stator blade of the first type 16a which is circumferentially closest to the radial plane and whose downstream end is located circumferentially on the same side as the lower surface face 43 of the pylon 18 with respect to the radial plane.

Each downstream stator blade of the first type 16a of the first group G1 is in a closed-pitch configuration relative to the downstream stator blades of the first type 16a of the second group G2. In other words, each downstream stator blade of the first type 16a of the second group G2 is in an open-pitch configuration relative to the downstream stator blades of the first type 16a of the first group G1. Such an arrangement facilitates the bypassing of the airflow around the pylon 18, thereby reducing pressure distortion rise between the pylon 18 and the downstream stator blades of the first type 16a, and avoiding boundary layer separation and the formation of recirculation zones on the downstream stator blades of the first type 16a which would increase aerodynamic losses and noise levels.

Remarkably, in the second configuration, each downstream stator blade of the first type 16a has different dimensional characteristics (i.e. a different aerodynamic profile) from the other downstream stator blades.

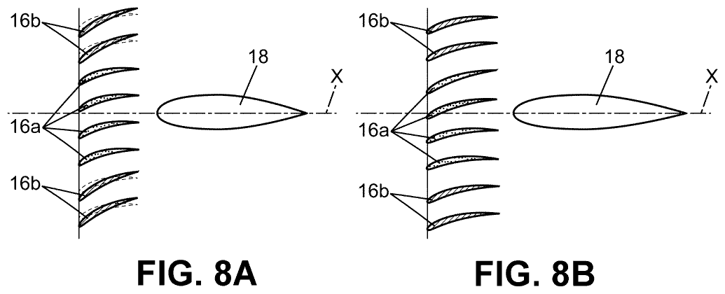

FIG. 8 shows a first configuration of the annular row of downstream stator blades 16. In the third configuration, each downstream stator blade of the first type 16a has identical dimensional characteristics (i.e. identical aerodynamic profile). This simplifies the manufacture of the propulsion system. In the third configuration, each downstream stator blade of the first type 16a can have an identical pitch angle γ (FIG. 8a), or the pitch angle γ of each downstream stator blade of the first type 16a can be different from the pitch angle γ of one or more of the other downstream stator blades of the first type 16a (FIG. 8b).

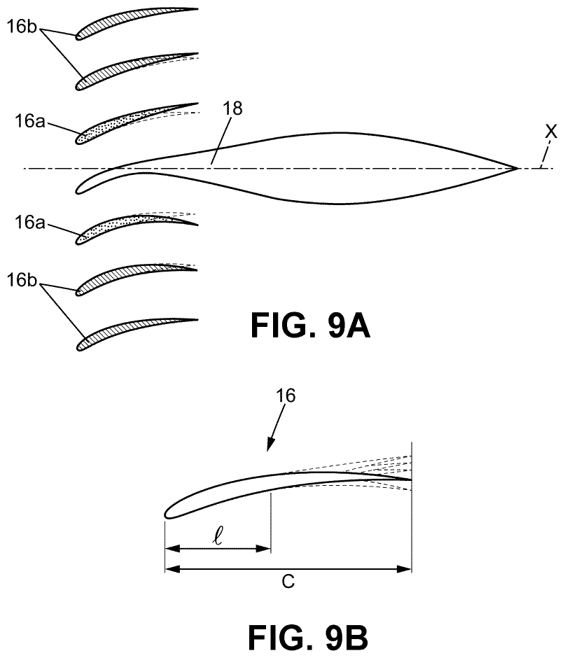

FIG. 9 shows a fourth configuration of the annular row of downstream stator blades. In the fourth configuration, the pylon 18 is connected to one of the downstream stator blades to form a unitary aerodynamic assembly. This reduces the drag forces associated with the pylon 18 and allows the integration of a downstream stator blade 16 at the angular position of the pylon 18.

Furthermore, in the fourth configuration, each downstream stator blade has identical dimensional characteristics (i.e. identical aerodynamic profile) on an upstream end portion that extends longitudinally over a relative chord length C of between 5% and 50%. In other words, for each section 30 of one of the downstream stator blades, there is a corresponding section 30 of another among the downstream stator blades which is disposed at the same radial distance from the longitudinal axis X and which has the same aerodynamic profile over a relative chord length C of the section 30 of between 5% and 50%, preferably between 10% and 30%. This simplifies the design, reduces the manufacturing costs of the turbomachine 10, and provides homogeneity at the leading edge of the downstream stator blades 16, which can be beneficial in reducing tonal interaction noise.

The pylon 18 also has an upstream end portion with identical dimensional characteristics (i.e. identical aerodynamic profile) to the identical upstream end portions of the downstream stator blades.

1. An aeronautical thruster having a longitudinal axis and comprising a hub, an annular row of unducted upstream rotor blades, and an annular row of unducted downstream stator blades, wherein the annular row of downstream stator blades comprises:
at least one downstream stator blade of a first type, each downstream stator blade of the first type being located around the longitudinal axis in a first angular sector around the longitudinal axis, each downstream stator blade of the first type having a fixed pitch, and
at least one downstream stator blade of a second type, each downstream stator blade of the second type being located around the longitudinal axis outside said first angular sector, each downstream stator blade of the second type having a variable pitch.

2. The aeronautical thruster according to claim 1, wherein the first angular sector extends over an angular range less than or equal to 180°.

3. The aeronautical thruster according to claim 1, wherein the annular row of downstream stator blades comprises between one and six downstream stator blades of the first type.

4. The aeronautical thruster according to claim 1, wherein at least two downstream stator blades of the first type have a different pitch angle (γ).

5. The aeronautical thruster according to claim 4, wherein the difference between the pitch angle of said two downstream stator blades of the first type is less than 120°, preferably less than 60°.

6. The aeronautical thruster according to claim 4, wherein said two downstream stator blades of the first type are circumferentially consecutive, the difference between the pitch angle of said two downstream stator blades of the first type being less than 45°.

7. The aeronautical thruster according to claim 1, wherein at least two downstream stator blades of the first type have an identical pitch angle (γ).

8. The aeronautical thruster according to claim 1, wherein each downstream stator blade of the first type has identical dimensional characteristics.

9. The aeronautical thruster according to claim 1, wherein at least two downstream stator blades of the first type have different dimensional characteristics.

10. The aeronautical thruster according to claim 1, wherein at least two downstream stator blades of the second type have a different pitch angle (γ).

11. The aeronautical thruster according to claim 10, wherein the difference between the pitch angle of said two downstream stator blades of the second type is less than 120°.

12. The aeronautical thruster according to claim 10, wherein said two downstream stator blades of the second type are circumferentially consecutive, the difference between the pitch angle of said two downstream stator blades of the second type being less than 20°.

13. The aeronautical thruster according to claim 1, in which each of the downstream stator blades of the first type and/or each of the downstream stator blades of the second type has a pitch angle (γ) which is determined as a function of the angular position of the downstream stator blade of the first type respectively of the second type, about the longitudinal axis, in particular according to a linear, parabolic, sinusoidal, logarithmic, or exponential law.

14. The aeronautical thruster according to claim 1, wherein each downstream stator blade of the second type has a pitch angle (γ) different from the pitch angle (γ) of the circumferentially adjacent downstream stator blade(s) of the second type.

15. The aeronautical thruster according to claim 1, wherein each downstream stator blade comprises a stack of sections in the radial direction, each section comprising an upstream leading edge and a downstream trailing edge between which extend a lower surface line and an upper surface line so as to define an aerodynamic profile, each section further comprising a chord defined by a portion of a straight line connecting the leading edge to the trailing edge, and wherein for each pair of a first downstream stator blade and a second downstream stator blade, each section of the first downstream stator blade has an identical aerodynamic profile to a corresponding section of the second downstream stator blade over an upstream end portion that extends longitudinally over a relative chord length of between 5% and 50%, said corresponding sections of the first downstream stator blade and the second downstream stator blade each being disposed at the same radial distance from the longitudinal axis.

16. A propulsion system for an aircraft, the propulsion system comprising the aeronautical thruster according to claim 1 and a pylon configured to attach the aeronautical thruster to the aircraft, the pylon extending in a direction comprising at least one radial component from a radially inner end by which the pylon is connected to the hub of the aeronautical thruster, the first angular sector being centred on a longitudinal median plane of the pylon.

17. The propulsion system according to claim 16, in which the pylon comprises a leading edge and a trailing edge between which extend on each side in the circumferential direction an upper surface face and a lower surface face, the upper surface face and the lower surface face of the pylon being at least on an upstream portion of the pylon, circumferentially disposed on either side of a radial plane defined by the longitudinal axis and a radial axis passing, at least in part, through the leading edge of the pylon, the annular row of downstream stator blades of the aeronautical thruster comprising:
a first group comprising one or more downstream blades of the first type which each have a downstream end located circumferentially on the same side as the upper surface face of the pylon with respect to the radial plane the first group comprising at least the downstream stator blade of the first type which is circumferentially closest to the radial plane and whose downstream end is located circumferentially on the same side as the upper surface face of the pylon with respect to the radial plane
a second group comprising one or more downstream blade(s) of the first type, each of which has a downstream end located circumferentially on the same side as the lower surface face of the pylon with respect to the radial plane, the second group comprising at least the first type downstream stator blade which is circumferentially closest to the radial plane and whose downstream end is located circumferentially on the same side as the lower surface face of the pylon with respect to the radial plane and
wherein each first type downstream stator blade of the first group is in a closed-pitch configuration relative to the first type downstream stator blades of the second group.

18. The propulsion system of claim 16, wherein the pylon is connected to one of the downstream stator blades so as to form a unitary aerodynamic assembly.

19. A method of operating the aeronautical thruster according to claim 1, the method comprising adjusting the pitch angle (γ) of each downstream stator blade of the second type in dependence on an incidence phase of operation of the aeronautical thruster.

20. A method of operating the propulsion system according to claim 16, the method comprising adjusting the pitch angle (γ) of each downstream stator blade of the second type in dependence on an incidence phase of operation of the aeronautical thruster.
